(19) United States
(12) Patent Application Publication
(10) Pub. No.: US 2019/0321761 A1
(43) Pub. Date: Oct. 24, 2019

(54) FILTER MEMBER AND METHOD OF MAKING SAME

(71) Applicant: Kohler Co., Kohler, WI (US)

(72) Inventors: Michael T. Carson, Sheboygan, WI (US); Stephanie R. Soendker, Sheboygan, WI (US); Kaitlyn D. Zdvorak, Sheboygan, WI (US); Hosseinali Saheb Ekhtiari, Sheboygan, WI (US)

(21) Appl. No.: 16/377,479

(22) Filed: Apr. 8, 2019

Related U.S. Application Data
(60) Provisional application No. 62/659,436, filed on Apr. 18, 2018.

(51) Int. Cl. B01D 39/20; C02F 1/00; C04B 35/10; C04B 35/18; C04B 35/626; C04B 35/64; C04B 38/06; C04B 38/00

(52) U.S. Cl. CPC B01D 39/2079; C02F 1/001; C04B 35/10; C04B 35/18; C04B 35/62695; B28B 3/02; C04B 38/0645; C04B 38/0054; B01D 2239/086; B01D 2239/10; B01D 2239/1216; C04B 35/64

(57) ABSTRACT

A method for fabricating a filter member includes: mixing a predetermined amount of zeolite with alumina to form a composite mixture; spraying a coating material onto the composite mixture to form a coated composite mixture including granules; filtering the granules to obtain granules having a predetermined length dimension; shaping the obtained granules to form a compacted disc having a predetermined thickness; and heat-treating the compacted disc to form a filter member.

### CROSS-REFERENCE TO RELATED PATENT APPLICATION

This application claims the benefit of and priority to U.S. Provisional Application No. 62/659,436, filed Apr. 18, 2018, the entire disclosure of which is hereby incorporated by reference herein.

### BACKGROUND

The present application relates to a ceramic filter membrane material for use in water purification applications. More specifically, the present application relates to a ceramic filter member that includes a high-strength aluminum oxide-based filter membrane for liquid filtration of microorganisms.

Existing technologies for water filtration filters may use membrane filters made of diatomaceous earth. These filters are fragile and can break easily during cleaning. Additionally, the fabrication processes for such membrane filters require heavy organic burnout to develop the pore structure in the filter. Moreover, diatomaceous earth-based filters often do not adequately remove microorganisms (e.g., bacteria, microbes, fungi, etc.), dissolve color, taste, and odor, or disinfection byproduct precursors in water filtration processes. Diatomaceous earth-based filters are limited for liquids having low turbidity and may require additional components (e.g., coagulant and filter aids, etc.) for effective microorganism removal, thus increasing the cost of use of such filters.

It would be advantageous to provide an improved ceramic filter membrane material for liquid filtration of microorganisms that overcomes the foregoing challenges. These and other advantageous features will be apparent to those reviewing the present disclosure.

### SUMMARY

An exemplary embodiment relates to a method for fabricating a filter member comprising: mixing a predetermined amount of zeolite with alumina to form a composite mixture; spraying a coating material onto the composite mixture to form a coated composite mixture including granules; filtering the granules to obtain granules having a predetermined length dimension; shaping the obtained granules to form a compacted disc having a predetermined thickness; and heat-treating the compacted disc to form a filter member.

In some exemplary embodiments, the mixing and spraying are concurrently performed.

In some exemplary embodiments, the spraying is conducted until the coated composite mixture achieves a moisture content in the range of about 6% L to about 18% L.

In some exemplary embodiments, the filtering retains granules having at least one length dimension smaller than about 840 μm.

In some exemplary embodiments, the shaping is conducted by a pressing die operating with a pressing force in the range of about 45 bar to about 85 bar.

In some exemplary embodiments, the compacted disc has a thickness in the range of about 0.1 inch to about 0.4 inch.

In some exemplary embodiments, the compacted disc has a thickness in the range of about 0.200 inch to about 0.365 inch.

In some exemplary embodiments, heat-treating comprises a first heat-treating step and a second heat-treating step.

In some exemplary embodiments, the first heat-treating step is conducted at a temperature in the range of about 400° C. to about 800° C. for a time in the range of about 2 hours to about 5 hours.

In some exemplary embodiments, the second heat-treating step is conducted at a temperature in the range of about 950° C. to about 1400° C. for a time in the range of about 15 minutes to about 45 minutes.

In some exemplary embodiments, the alumina is included in the range of about 30 wt % to about 60 wt % of the total composite mixture.

In some exemplary embodiments, the zeolite is included in the range of about 25 wt % to about 60 wt % of the total composite mixture.

In some exemplary embodiments, the composite mixture further comprises zinc stearate.

In some exemplary embodiments, the zinc stearate is included in the range of about 0 wt % to about 15 wt %.

In some exemplary embodiments, the zeolite is at least one of hydrous sodium aluminosilicate, anhydrous sodium aluminosilicate, potassium aluminosilicate, or hydrous calcium sodium aluminosilicate.

Another exemplary embodiment relates to a ceramic filter member formed by any of the methods described herein, having a pore size in the range of about 1 μm and about 10 μm.

In some exemplary embodiments, the pore size is in the range of about 3 μm and about 6 μm.

In some exemplary embodiments, the ceramic filter member has a diameter in the range of about 4.0 inches to about 8.0 inches.

In some exemplary embodiments, the ceramic filter member has a thickness in the range of about 0.1 inch to about 0.6 inch.

In some exemplary embodiments, the ceramic filter member has a thickness is in the range of about 0.2 inch to about 0.5 inch.

In some exemplary embodiments, the ceramic filter member has a pore necking size in the range of about 0.1 μm to about 2 μm.

In some exemplary embodiments, the ceramic filter member has a pore necking size is in the range of about 0.8 μm to about 1.2 μm.

### BRIEF DESCRIPTION OF THE DRAWINGS

FIG. 1 is a side view of a ceramic filter member according to an exemplary embodiment.

FIG. 2 is a top view of the ceramic filter member of FIG. 1.

FIG. 3 is a perspective view of the ceramic filter member of FIG. 1.

FIG. 4 is a bottom view of the ceramic filter member of FIG. 1.

FIG. 5 is a cross-sectional view of the ceramic filter member of FIG. 4 taken along line B-B.

FIG. 6 is a cross-sectional view of the ceramic filter member of FIG. 4 taken along line A-A.

FIGS. 7-8 are detail views of the ceramic filter member of FIG. 6.

FIG. 9 is a flow-chart illustrating a method of forming the ceramic filter member of FIG. 1 according to an exemplary embodiment.

### DETAILED DESCRIPTION

The present disclosure relates to a filter member (e.g., membrane, etc.) that incorporates a calcined alumina body structure and that utilizes a zeolite/zinc stearate material to assist in pore formation within the bulk material. Some benefits of such a configuration include, for example, (1) a reduced use of binder material, (2) a significant reduction in loss-on-ignition, and (3) a more stable and reproducible pore size formation. The fabrication methods described herein produce a more robust ceramic filter membrane material using alumina and having a longer service life due, in part, to minimal loss of weight during heat-treatment processes (i.e. “firing losses” approaching zero).

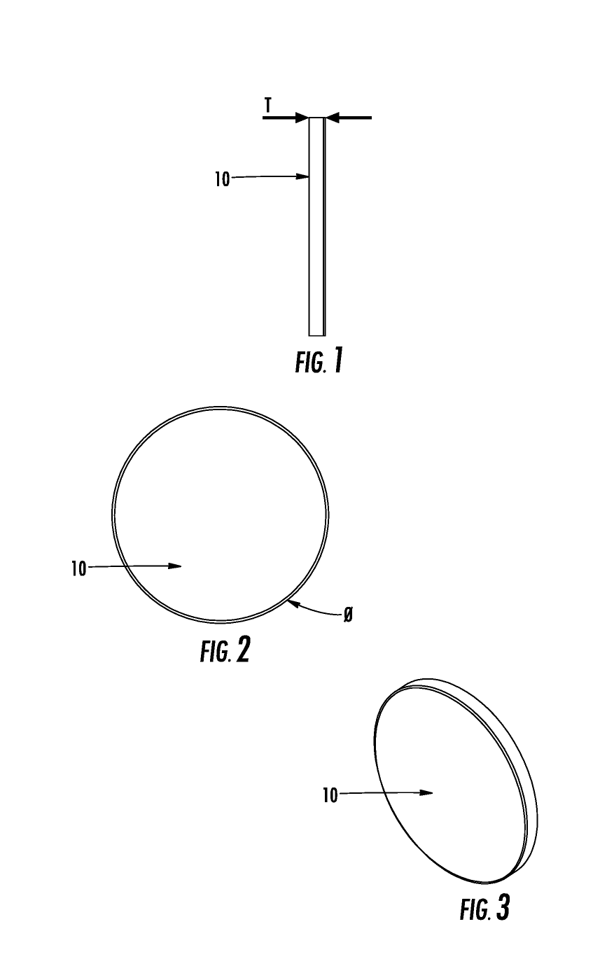

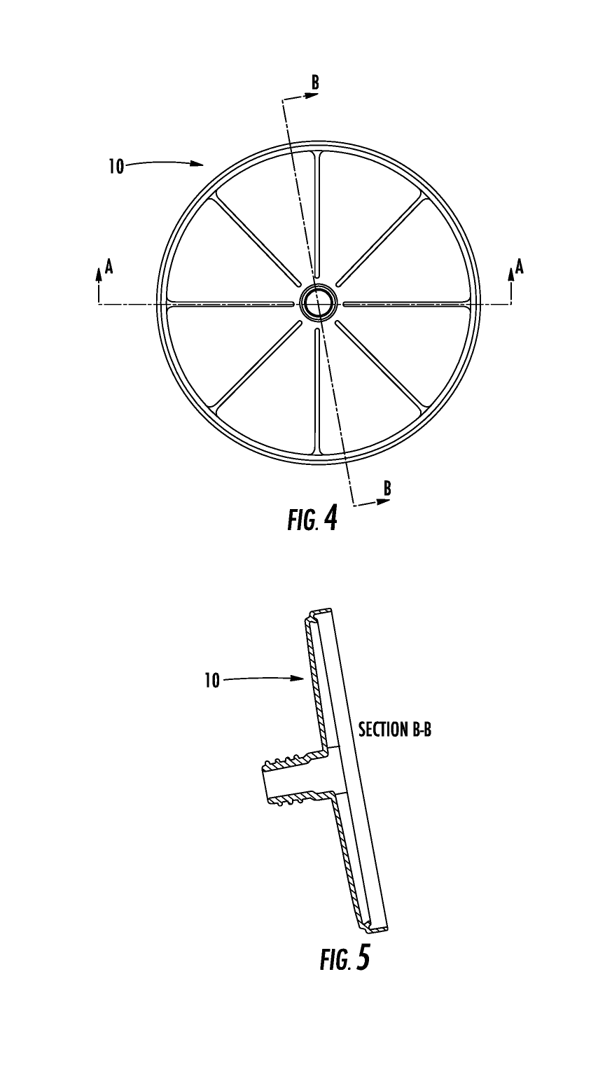

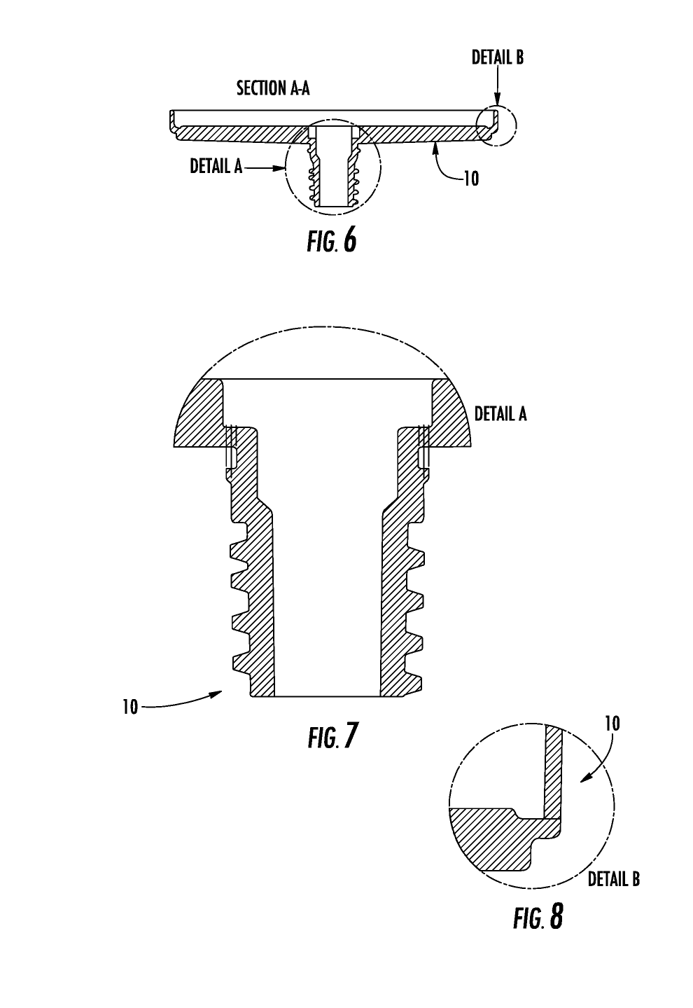

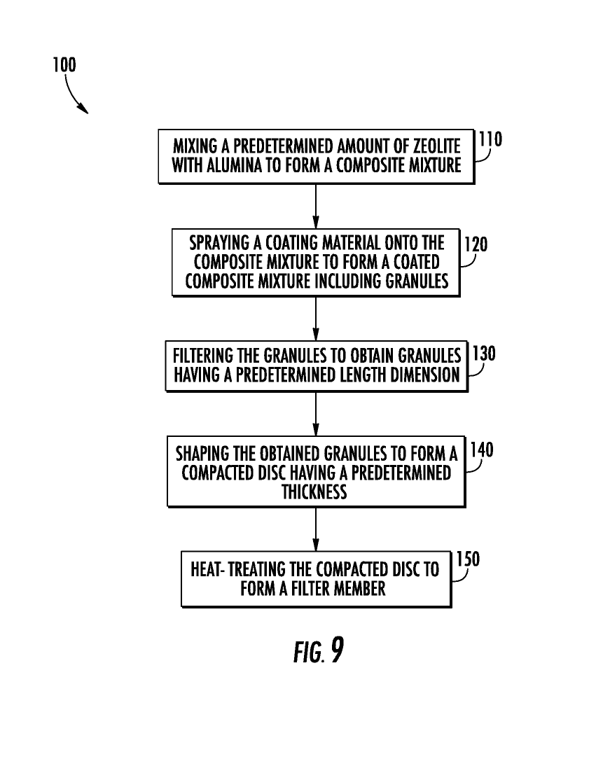

According to an exemplary embodiment shown in FIG. 9, a method 100 for fabricating a filter member 10 (shown in FIGS. 1-8) is shown according to an exemplary embodiment. The method 100 includes a step 110 of mixing a predetermined amount of zeolite with an alumina material to form a composite mixture. The mixing may occur in an intensive mixer with a pressurized binder delivery system. Other mixing methods include ribbon mixers and planetary mixers. In some embodiments, calcined alumina may be included in the range of about 30 wt % to about 60 wt % of the total composite mixture. In some embodiments, the calcined alumina may have a specific surface area in the range of about 0.5 m2/g to about 0.9 m2/g (e.g., 0.7 m2/g). In some embodiments, the calcined alumina may have a particle size distribution (D90) in the range of about 30 μm to about 60 μm (e.g., 45 μm). The alumina may be pre-prepared by dry milling in continuous feed ball mills using ceramic media and ground from normal soda and low soda calcined aluminas.

In some embodiments, zeolite may be included in the range of about 25 wt % to about 60 wt % of the total composite mixture. In some embodiments, the zeolite may be at least one of hydrous sodium aluminosilicate, anhydrous sodium aluminosilicate, potassium aluminosilicate, or hydrous calcium sodium aluminosilicate. The zeolite may be pre-conditioned to prepare zeolite particles in the range of about 1 μm to about 480 μm. In some embodiments, the zeolite particles may have a diameter in the range of about 1 μm to about 45 μm. In other embodiments, the zeolite particles may have a diameter in the range of about 45 μm to about 270 μm. In yet other embodiments, the zeolite particles may have a diameter in the range of about 270 μm to about 480 μm.

In some embodiments, the composite mixture may also include low levels of zinc stearate in the range of about 0 wt % to about 15 wt % of the total composite mixture. In some embodiments, the zinc stearate particles may have a diameter in the range of about 40 μm to about 60 μm. In some embodiments, the zinc stearate particles may have a diameter in the range of about 50 μm to about 55 μm (e.g., 53 μm). In one embodiment, a composite mixture is formed by mixing the calcined alumina, zeolite, and stearate material in an intensive mixer with a pressurized, atomizing binder delivery system (e.g., an airless spray nozzle) for a time in the range of about 15 seconds to about 2 minutes (e.g., 30 seconds) or until the composite mixture is homogenous.

Still referring to FIG. 9, the method 100 further includes a step 120 of spraying a coating material onto the composite mixture to form a coated composite mixture. The coated composite mixture may be comprised of granules having various sizes. In some embodiments, the coating material comprises a binder/water mixture comprising emulsions based on non-ionic acrylic copolymers (e.g., Resicel E0N®, etc.), stabilizing emulsions of paraffins and waxes (e.g., Cerfabol®, etc.), and water. In one exemplary embodiment, the binder/water mixture comprises wax emulsion in a range of about 1-10% (e.g., 7%). The binder/water mixture may be sprayed on the dry composite mixture during mixing (i.e. the mixing and spraying are concurrently performed). In some embodiments, the mixing occurs during cycling of the spraying process. For example, the mixing may occur while cycling at intervals in the range of about 15-40 seconds ‘on’ (e.g., 25-35 seconds) and about 0-40 seconds ‘off’ (e.g., 25-35 seconds). In other embodiments, the binder/water mixture may be sprayed on individual components of the dry composite mixture prior to mixing. In yet other embodiments, the binder/water mixture may be sprayed on the dry composite mixture after mixing. The spraying may be conducted until the coated composite mixture achieves a moisture content in the range of about 5% L to about 20% L. In an exemplary embodiment, the spraying may be conducted until the coated composite mixture achieves a moisture content in the range of about 6% L to about 18% L. The binder may be included in the range of about 1 wt % to about 5 wt % of the total coated composite mixture.

The method 100 also includes a step 130 of filtering (e.g., screening, etc.) the granules of the coated composite structure to obtain granules having a predetermined length dimension. In one embodiment, filtering may be conducted using a stainless steel screen (e.g., sieve, etc.), such that the filtering retains granules having at least one length dimension smaller than about 840 μm. In this manner, large agglomerations or granules are removed from the dried, coated composite mixture.

Still referring to FIG. 9, the method 100 further includes a step 140 of shaping the obtained granules to form a compacted disc having a predetermined thickness. In one embodiment, the obtained granules are shaped using a pressing die. After the granules have been filtered, the granules are then loaded into a pressing die having a cavity with at least one length dimension being at least six inches. For example, the pressing die may have a cavity with a diameter being at least six inches (e.g., 6.125 inches, etc.). In another embodiment, the pressing die may have a cavity with at least one length dimension being less than six inches. In one embodiment, the cavity has a depth in the range of about 0.1 to about 1 inch. For example, the cavity may have a depth (shim depth) in the range of about 0.25 to about 0.8 inch or about 0.5 to about 0.7 inch (e.g., 0.66 inch). The screened granule material is loaded into the cavity such that the powder is substantially evenly deposited and flush with a top edge of the pressing die cavity. In one embodiment, the pressing die may then be pressed on a 70T C-frame press operating with a pressing force in the range of about 45 bar to about 85 bar (e.g., 70-75 bar). Pressing forces lower than or higher than the disclosed ranges result in deteriorated mechanical properties of the resultant disc (i.e. visible cracking and/or crumbling edges). Within the disclosed pressing force ranges, a well-compacted disc is ejected from the pressing die having no visible defects (i.e. cracking, crumbling edge, etc.). In one embodiment, the compacted disc has a thickness in the range of about 0.1 inch to about 0.4 inch. In another embodiment, the compacted disc has a thickness in the range of about 0.200 inch to about 0.365 inch (e.g., 0.249 inch). In one embodiment, the compaction ratio (i.e. the ratio between the thickness of the granules pre-pressing to the thickness of the compacted disc post-pressing) is in the range of about 1.8 to about 2.4 (e.g., 2.0).

Still referring to FIG. 9, the method 100 further includes a step 150 of heat-treating the compacted disc to form a filter member (e.g., filter disc, etc.), such as the filter member 10 shown in FIGS. 1-8. In some embodiments, the heat-treating comprises a first heat-treating step and a second heat-treating step. In one embodiment, the first heat-treating step is a binder burnout conducted at a temperature in the range of about 400° C. to about 800° C. for a time in the range of about 2 hours to about 5 hours (e.g., 3 hours). In one embodiment, the second heat-treating step is conducted at a temperature in the range of about 950° C. to about 1400° C. for a time in the range of about 15 minutes to about 45 minutes (e.g., 30 minutes). Each compacted disc may be heat-treated in a kiln, furnace, oven, or similar heat-treating vessel and is loaded either horizontally on a deck of the kiln or horizontally on a refractory tile setter of the kiln.

FIGS. 1-8 illustrate a ceramic filter member 10 obtained by the method 100 of FIG. 9, according to an exemplary embodiment. The ceramic filter member 10 may be formed by the various methods disclosed herein to define a high-strength aluminum oxide-based filter membrane having a pore size in the range of about 1 μm and about 10 μm. In one exemplary embodiment, the ceramic filter member 10 may have a pore size that is in the range of about 3 μm and about 6 μm. The ceramic filter member 10 may have a diameter 0 in the range of about 4.0 inches to about 8.0 inches (e.g., 6.0 inches). In some embodiments, the ceramic filter member 10 may have a thickness Tin the range of about 0.1 inch to about 0.6 inch. In one exemplary embodiment, the ceramic filter member 10 may have a thickness T in the range of about 0.2 inch to about 0.5 inch (e.g., 0.46 inch). In some embodiments, the ceramic filter member 10 may have a pore necking size in the range of about 0.1 μm to about 2 μm. In one exemplary embodiment, the ceramic filter member 10 may have a pore necking size in the range of about 0.8 μm to about 1.2 μm (e.g., 1 μm). In this manner, the pores created in the body of the ceramic filter member 10 can define channels through which the zeolite component may melt and pool.

Thus, the present disclosure describes a ceramic filter design using a calcined alumina body structure and having a zeolite/zinc stearate pore formation that can, advantageously, filter bacterial agents or other microorganisms from water. Other uses of the disclosed ceramic filter member may be as a gas adsorbent, contaminant filtration device in oil and gas applications, a water desalination device, etc. Benefits of the fabrication methods described herein include, for example, (1) a reduced use of binder material, (2) a significant loss-on-ignition reduction, and (3) a more stable and reproducible pore size formation. The resultant ceramic filter members are more robust and have a longer service life than ceramic filters formed using conventional methods. More particularly, firing losses during the heat treatment step result in minimal losses of weight of the filter member.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the ceramic filter membrane as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for fabricating a filter member, comprising:
mixing a predetermined amount of zeolite with alumina to form a composite mixture;
spraying a coating material onto the composite mixture to form a coated composite mixture including granules;
filtering the granules to obtain granules having a predetermined length dimension;
shaping the obtained granules to form a compacted disc having a predetermined thickness; and
heat-treating the compacted disc to form a filter member.

2. The method of claim 1, wherein the mixing and spraying are concurrently performed.

3. The method of claim 1, wherein the spraying is conducted until the coated composite mixture achieves a moisture content in the range of about 6% L to about 18% L.

4. The method of claim 1, wherein the filtering retains granules having at least one length dimension smaller than about 840 μm.

5. The method of claim 1, wherein the shaping is conducted by a pressing die operating with a pressing force in the range of about 45 bar to about 85 bar.

6. The method of claim 1, wherein the compacted disc has a thickness in the range of about 0.1 inch to about 0.4 inch.

7. The method of claim 6, wherein the compacted disc has a thickness in the range of about 0.200 inch to about 0.365 inch.

8. The method of claim 1, wherein heat-treating comprises a first heat-treating step and a second heat-treating step.

9. The method of claim 8, wherein the first heat-treating step is conducted at a temperature in the range of about 400° C. to about 800° C. for a time in the range of about 2 hours to about 5 hours.

10. The method of claim 8, wherein the second heat-treating step is conducted at a temperature in the range of about 950° C. to about 1400° C. for a time in the range of about 15 minutes to about 45 minutes.

11. The method of claim 1, wherein the alumina is included in the range of about 30 wt % to about 60 wt % of the total composite mixture.

12. The method of claim 1, wherein the zeolite is included in the range of about 25 wt % to about 60 wt % of the total composite mixture.

13. The method of claim 1, wherein the composite mixture further comprises zinc stearate.

14. The method of claim 13, wherein the zinc stearate is included in the range of about 0 wt % to about 15 wt %.

15. The method of claim 1, wherein the zeolite is at least one of hydrous sodium aluminosilicate, anhydrous sodium aluminosilicate, potassium aluminosilicate, or hydrous calcium sodium aluminosilicate.

16. A ceramic filter member formed by the method of claim 1 having a pore size in the range of about 1 μm and about 10 μm.

17. The ceramic filter member of claim 16, wherein the pore size is in the range of about 3 μm and about 6 μm.

18. The ceramic filter member of claim 16 having a diameter in the range of about 4.0 inches to about 8.0 inches.

19. The ceramic filter member of claim 16 having a thickness in the range of about 0.1 inch to about 0.6 inch.

20. The ceramic filter member of claim 16 having a pore necking size in the range of about 0.1 μm to about 2 μm.
